(19) United States
(12) Patent Application Publication
(10) Pub. No.: US 2014/0233051 A1
(43) Pub. Date: Aug. 21, 2014

(54) DOCUMENT DISTRIBUTION SERVER AND PROGRAM FOR DOCUMENT DISTRIBUTION SERVER

(71) Applicants: Toshiba Tec Kabushiki Kaisha, Tokyo (JP); Kabushiki Kaisha Toshiba, Tokyo (JP)

(72) Inventors: TAKAHIRO HAGIWARA, Chiba-ken (JP); KAZUHIRO OGURA, Kanagawa-ken (JP); KAZUNORI HIRABAYASHI, Kanagawa-ken (JP); AKIHIRO MIZUTANI, Shizuoka-ken (JP); TOSHIHIRO IDA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/185,785

(22) Filed: Feb. 20, 2014

(30) Foreign Application Priority Data
Feb. 20, 2013 (JP) 2013-031206

(51) Int. Cl. G06F 3/12

(52) U.S. Cl. CPC G06F 3/1248; G06F 3/1205; G06F 3/1245
USPC 358/1.13

(57) ABSTRACT

A document distribution server a data conversion unit configured to convert document data into a common format data that have the same appearance when displayed on a display device and when printed with a printing device, a receiving unit configured to receive a request to display the document data in the display device and to receive a request to print the document data in the printing device, and a transmission unit configured to transmit the common format data to the display device when the request to display the document data is received from the display device and to transmit the common format data to the printing device when the request to print the document data is received from the printing device.

### CROSS-REFERENCE TO RELATED APPLICATION

This application is based upon and claims the benefit of priority from Japanese Patent Application No. 2013-031206, filed Feb. 20, 2013, the entire contents of which are incorporated herein by reference.

### FIELD

Embodiments described herein relate generally to a document distribution server and a program for a document distribution server.

### BACKGROUND

In the related art, an application for reading document data may be distributed for use in reading document data. A document file is opened using the application. For example, the document file may be converted into PDF format and distributed, and the converted document is viewed using PDF reading software.

However, a document which is read using a first document reading device may appear different when read on another document reading device. Thus, there is a concern that problems will occur, such as the occurrence of corrupted text and differences in format of the output result. For example, the print output or the display output of the document data may be different according to the output device.

### DESCRIPTION OF THE DRAWINGS

FIG. 1 illustrates an overall configuration of a document distribution system, according to a first embodiment.

FIG. 2 illustrates a document distribution server, according to the first embodiment.

FIG. 3 illustrates a configuration of the hardware of the document distribution server, according to the first embodiment.

FIG. 4 is a flow chart of example operations of the document distribution system, according to the first embodiment.

FIG. 5 illustrates an overall configuration of a document distribution system, according to a second embodiment.

FIG. 6 is a flow chart of example operations of the document distribution system, according to the second embodiment.

### DETAILED DESCRIPTION

A document distribution server is provided. An item displayed in a certain display terminal is prevented from being printed or displayed differently in a printing device or another display terminal.

In general, according to one embodiment, there is provided a document distribution server including a data conversion unit configured to convert document data into a common format data that have the same appearance when displayed on a display device and when printed with a printing device, a receiving unit configured to receive a request to display the document data in the display device and to receive a request to print the document data in the printing device, and a transmission unit configured to transmit the common format data to the display device when the request to display the document data is received from the display device and to transmit the common format data to the printing device when the request to print the document data is received from the printing device.

Hereinafter, the embodiments will be described with reference to the drawings.

### First Embodiment

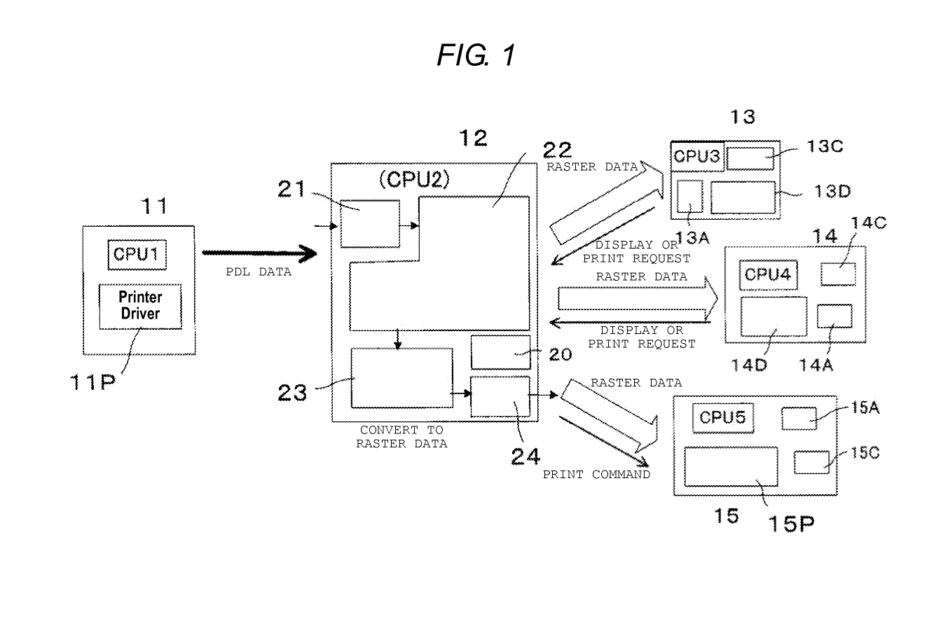

The overall configuration of a document distribution system according to a first embodiment is shown in FIG. 1. The document distribution system includes a document distribution server 12, a tablet computer 13, a computer 14 and a printer 15. The document distribution server 12 converts Page Description Language (PDL) data of a created document into raster data. The created document may have been created, for example, in a computer 11. The computer 11 functions as a document creator. The tablet computer 13 receives and displays the raster data that was converted and transmitted by the document distribution server. The computer 14, in the same manner as the tablet computer 13, also receives and displays the raster data transmitted from the document distribution server 12. The printer 15 receives and prints the raster data transmitted from the document distribution server 12.

In the first embodiment, in the document distribution server 12, a CPU 2 converts the PDL data into raster data.

The tablet computer 13 and the computer 14 may be display devices which display raster data. There may be one, or two or more such devices. In addition, the computer 11 may be a device which may create documents. There may also be another document creation device. In the computer 11, a CPU 1 controls a printer driver 11P to convert the created document into PDL data.

The printer 15 or the like may be installed near to the tablet computer 13 and/or the computer 14. A display request signal is transmitted from the tablet computer 13 or the computer 14 to the document distribution server 12. The raster data is transmitted from the document distribution server 12 to the terminals (tablet computer 13 and computer 14) and displayed on the respective display screens thereof. Furthermore, when the displayed document is to be printed, a print request signal is transmitted to the document distribution server 12. The document distribution server 12 then transmits a print command signal to the printer 15, and the document which has been displayed is printed.

The tablet computer 13 includes a screen of approximately 6 inches to 11 inches, for example, and enables the control of operations through a touch screen interface. Furthermore, the tablet computer 13 includes a CPU 3, a memory device 13A, a display unit 13D, and a display and print request unit 13C. The CPU 3 performs overall control of the tablet computer 13. The memory device 13A is controlled by the CPU 3 to store the raster data and the like. The display unit 13D is controlled by the CPU 3 to display the raster data, which is stored by the memory device 13A, on the display screen of the display device. The display and print request unit 13C is controlled by the CPU 3 to generate the display request signal and the print request signal when the display request or the print request is input by a user. In FIG. 1, in order to facilitate understanding of the functions, the CPU 3 is shown separately from the memory device 13A and the display and print request unit 13C. However, in hardware terms, the CPU 3, which is the computing unit, the memory unit (ROM or RAM) and the input-output control unit are configured integrally, are electrically connected to each other, and are configured to perform the operations described above, i.e., generate the display and print request signals and the like.

The computer 14 is a personal computer which includes a CPU 4, a memory unit 14A, a display unit 14D and a display and print request unit 14C. The CPU 4 performs general control of the computer 14. The memory unit 14A is controlled by the CPU 4 to store the raster data or the like which is transmitted from the document distribution server 12. The display unit 14D is controlled by the CPU 4 to display the raster data which is stored by the memory unit 14A on the display screen of the display device. The display and print request unit 14C is controlled by the CPU 4 to generate the display request signal, the print request signal and the like based on an input from a user.

Similar to the tablet computer 13, in FIG. 1, in order to facilitate understanding of the functions, the CPU 4 is shown separately from the memory unit 14A and the display and print request unit 14C in the computer 14 as well. However, in hardware terms, the CPU 4, the memory unit 14A (the ROM or the RAM) and the input-output control unit are configured integrally, are electrically connected to each other, and are configured to perform the operations described above, i.e., generate the display and print request signals and the like.

The printer 15 includes a CPU 5, a memory unit 15A, a display and print request unit 15C and a printing unit 15P. The CPU 5 performs overall control. The memory unit 15A receives and temporarily stores the raster data or the like under the control of the CPU 5. The display and print request unit 15C generates the control signal for requesting the document distribution server 12 to display or print. The printing unit 15P is controlled by the CPU 5 to print when the print command signal is received from the document distribution server 12.

The document distribution server 12 includes a request transceiver unit 20 which transmits the print command signal. The print command signal commands the printer 15 to print when the CPU 2 detects the display request signal and the print request signal transmitted from the tablet computer 13 or the computer 14. In this instance, the tablet computer 13 or the computer 14 serves as the display device (the terminal). The document distribution server 12 also includes a PDL data accumulation unit 21 which detects and temporarily accumulates the PDL data, which is transmitted from the computer 11, under the control of the CPU 2. In addition, the document distribution server 12 includes an analysis and conversion processing unit 22, a rendering unit 23, a raster data accumulation unit 24, and the like. The analysis and conversion processing unit 22 is controlled by the CPU 2 to analyze the data accumulated in the PDL data accumulation unit 21 and convert the data into a unified image. The rendering unit 23 is controlled by the CPU 2 to render the data which is converted by the analysis and conversion processing unit 22 and change the data into raster data. The raster data accumulation unit 24 is controlled by the CPU 2 to temporarily accumulate the raster data obtained by the rendering unit 23.

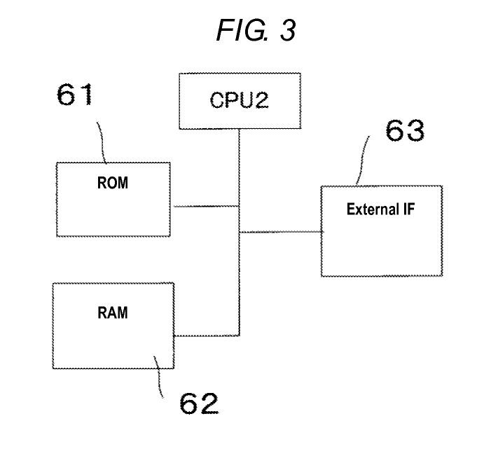

In FIG. 1, in order to facilitate understanding of the functions, the CPU 2 is represented separately from the request transceiver unit 20, the PDL data accumulation unit 21, the analysis and conversion processing unit 22, the rendering unit 23, the raster data accumulation unit 24 and a RIP unit 30. However, in hardware terms, as shown enlarged in FIG. 3, the CPU 2 includes Read Only Memory (ROM) 61, Random Access Memory (RAM) 62, and an input-output control unit (external interface) 63, which controls the external input and output, are configured integrally. The document distribution server 12 includes the CPU 2, ROM 61, RAM 62, and the external IF 63. The CPU 2 performs overall control of the document distribution server 12. The ROM 61 stores various programs and the like. The RAM 62 temporarily stores various types of variable data, image data and the like, and is rewritable. The external IF 63 receives data from outside via a network cable or the like and transmits data to the outside.

Each of the components in the document distribution server 12 is integrally arranged, electrically connected, and controlled by the CPU 2 to perform the functions of each component described below, including processes such as reception of the display request signal, accumulation of the PDL data, analysis and conversion from the raster data, rendering, and accumulation of the raster data. The PDL data is input via the input-output control unit, the recognition, analysis, conversion, rendering and the like of the data is performed by the computing unit, and the converted raster data is temporarily stored in the memory unit (the RAM).

The analysis and conversion processing unit 22 and the rendering unit 23 together form an analysis and rendering unit. The conversion to raster data, that is, the analysis in the analysis and conversion processing unit 22 and the rendering in the rendering unit 23 are carried out by a Raster Image Processor (RIP).

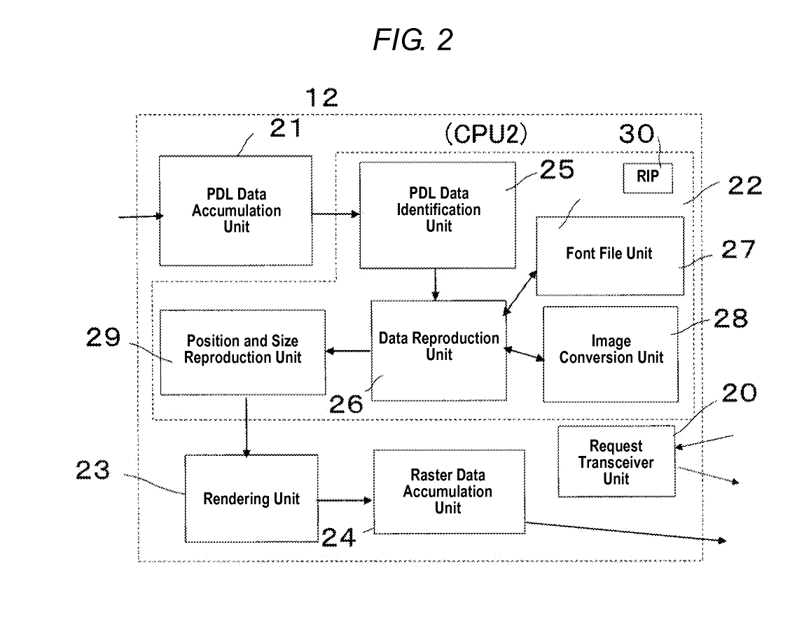

A s configuration of the document distribution server 12 is shown in FIG. 2. The analysis and conversion processing unit 22 of the document distribution server 12 includes a PDL data identification unit 25, a data reproduction unit 26, a font file unit 27, an image conversion unit 28, a position and size reproduction unit 29 and the RIP unit 30. The PDL data identification unit 25, for example, identifies the PDL data which has been temporarily accumulated in the PDL data accumulation unit 21 (which is a portion of the memory unit) one page at a time. The data reproduction unit 26 (part of the computing unit) individually converts each object such as character codes and images which are identified by the PDL data identification unit 25. The font file unit 27 stores the fonts corresponding to the character codes in the memory unit, and is used when reproducing the character codes in the data reproduction unit 26. The image conversion unit 28 converts images, including photographs, into binary data. The position and size reproduction unit 29 performs position changing, size changing, rotating and the like according to the position, size and the like of the data which is reproduced by the data reproduction unit 26.

The RIP unit 30 performs the conversion from PDL data to raster data. The RIP unit 30 is, for example, stored in an auxiliary memory device as a program. The auxiliary memory device includes a ROM unit, on which a program or the like is stored in advance, and which is not writable, and a RAM unit, onto which data is writable.

In FIG. 2, in order to facilitate understanding of the functions, the CPU 2 is represented separately from the PDL data identification unit 25, the data reproduction unit 26, the font file unit 27, the image conversion unit 28, the position and size reproduction unit 29 and the RIP unit 30. However, in hardware terms, the RIP, the computing unit, the memory unit (the ROM and the RAM), the input-output control unit and the like are configured integrally as the analysis and conversion processing unit, are electrically connected, and are configured to perform the identification of the PDL data, the data reproduction, the reproduction of the position and the size, the RIP processing and the like.

The CPU 2 of the document distribution server 12 reads, analyzes and RIP processes the PDL data. The raster data is generated from the PDL data by expanding the characters, rendering lines and expanding embedded photographs and the like. The CPU 2 of the document distribution server 12 accumulates the generated raster data in the raster data accumulation unit 24.

The PDL data identification unit 25, the data reproduction unit 26 and the position and size reproduction unit 29 include a memory region which stores screens in one page units. In a working region within the memory region, the data converted by the font file unit 27 and the image conversion unit 28 is replaced.

The rendering unit 23 performs processing for smoothly displaying the data which is replaced in the position and size reproduction unit 29 using RIP processing.

The tablet computer 13 is an electronic apparatus which is widely used as a mobile device and may be controlled by the CPU 3 to display the raster data transmitted from the document distribution server 12 on the display unit 13D according to an operation of the user. In addition, the computer 14 is an ordinary personal computer in common use and is controlled by the CPU 4 to display the raster data, which is transmitted from the document distribution server 12, on the display unit 14D. The tablet computer 13 and the computer 14 may be referred to collectively as the display terminal.

The tablet computer 13 and the computer 14 respectively include the display and print request units 13C and 14C. When the display and print request units 13C and 14C receive a request to display a specific part of a document from the user, the display and print request units 13C and 14C specify the document and transmit a display request signal to the request transceiver unit 20 of the document distribution server 12. Furthermore, when the part of the document is to be printed, the tablet computer 13 and the computer 14 transmit a print request signal to the document distribution server 12.

After the request transceiver unit 20 receives the display request signal from the tablet computer 13 or the computer 14, the request transceiver unit 20 transmits the raster data of the designated document to the display terminal (the tablet computer 13 or the computer 14) from which a request is issued. When the request transceiver unit 20 receives the print request signal from the tablet terminal 13 or the computer 14, the request transceiver unit 20 transmits the print request signal, which commands the printing of the document, to the printer 15.

The printer 15 is used to print document data and the like, and is controlled by the CPU 5. The printer 15 is subsequently controlled by the RIP to print on the basis of the raster data, which is converted from the PDL data. In the first embodiment, the PDL data, which is converted using PDL in the computer 11, is converted to raster data in the document distribution server 12 by the control of the CPU 2 and is subsequently transmitted to the printer 15. Therefore, in the printer 15, the CPU 5 controls the printing unit 15P to print on the basis of the raster data transmitted from the document distribution server 12. When the print request signal is transmitted to the printer 15 from the request transceiver unit 20, the CPU 5 detects the print request signal and controls the printer 15 to print.

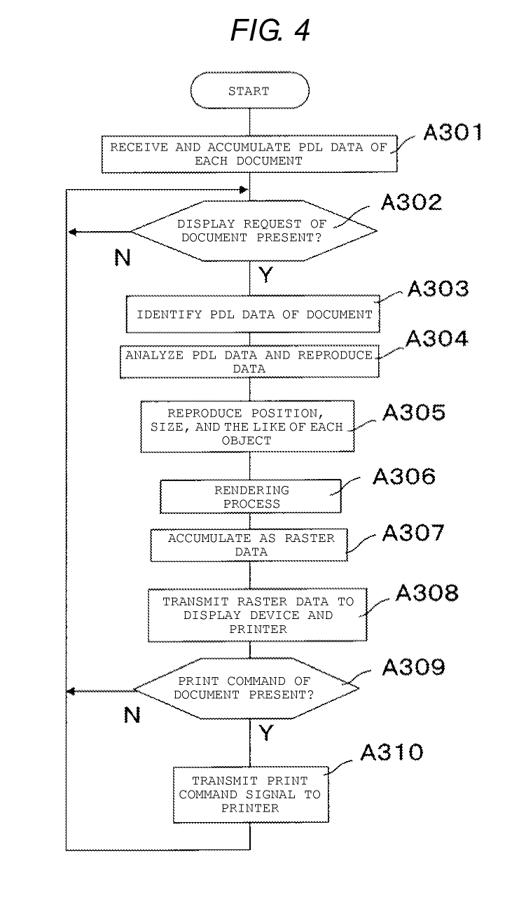

Next, example operations of the first embodiment will be described on the basis of the flow chart shown in FIG. 4. In Act A301, the CPU 2 accumulates the PDL data in the PDL data accumulation unit 21. The PDL is obtained from the computer 11, and is generated by the CPU 1 which converts the document created on the computer 11 into PDL data using the printer driver 11P.

In Act A302, the CPU 2 determines whether or not there is a display request of a document from the tablet computer 13 or the computer 14 via the request transceiver unit 20. When the CPU 2 determines that there is a display request of the document from the tablet computer 13 or the computer 14 (Y in Act A302), processing proceeds to Act A303. In Act A303, in the analysis and conversion processing unit 22, the CPU 2 performs analysis and conversion processing on the PDL data of the document that is designated in the display request signal.

In Act A304, the CPU 2 analyzes each object in the data reproduction unit 26 and reproduces the content thereof. For example, when the data is a font, the RIP causes the font file unit 27 to retrieve the font and realize the shape thereof. In addition, when the data is a photograph or an image, the RIP converts the photograph or the image into a specific shape using the image conversion unit 28. In Act A305, in the position and size reproduction unit 29, the CPU 2 determines and reproduces the position, size, color, orientation and the like of each object reproduced by the data reproduction unit 26, for example, one page at a time.

In Act A306, the overall image reproduced by the position and size reproduction unit 29 is rendered (the image is smoothed and the like) in the rendering unit 23 by the CPU 2, and raster data is obtained. In Act A307, he rendered raster data for each page is accumulated in the raster data accumulation unit 24. The CPU 2 also allows each page inside each document in the raster data accumulation unit 24 to be searchable.

In Act A308, the CPU 2 causes the raster data which is accumulated in the raster data accumulation unit 24 to be transmitted to the display terminal (the tablet computer 13 or the computer 14) from which there is a display request. Accordingly, the display terminal that receives the raster data displays the requested document on the display screen. When the displayed document is viewed and there is a portion to be printed, the CPU (CPU 3 or CPU 4) causes the display terminal to transmit the print request signals from the respective display and print request unit (13C or 14C) to the document distribution server 12.

The CPU 2 causes the request transceiver unit 20 of the document distribution server 12 to receive the print request signals. In Act A309, the CPU 2 controls the request transceiver unit 20 to determine whether or not there is a print request from the display terminal. In Act A310, when the CPU 2 determines that there is a print request (Y in Act A309), the CPU 2 controls the request transceiver unit 20 to transmit the print command signal to the printer 15.

In the printer 15, the CPU 5 controls the printing unit 15P to print on the basis of the raster data received beforehand.

When the printing in the printer 15 completes and when there is no print command (N in Act A309), the process returns to Act A302 again and the CPU 2 detects whether or not there is a display request of a document from each of the display terminals. The request transceiver unit 20 detects whether or not the display request signal is received by. In parallel with the detection, the CPU 2 also controls the accumulation of the PDL data that is transmitted from the computer 11 and the like in the PDL data accumulation unit 21.

In this manner, the CPU 2 causes the tablet computer 13 and the computer 14, which are the display terminals, to display the document to be viewed. In addition, when the document is to be printed, the document is printed using the printer in the same format as it is displayed. In other words, since the data displayed by the display terminal and the data printed by the printer are common, the document may be printed using the printer in the same format as it is displayed.

According to the embodiment, the document may be printed using the printer 15 so as to appear the same as when viewed on the screen of the display terminal.

In the embodiment, the PDL data input to the document distribution server 12 is temporarily accumulated in a searchable manner in the PDL data accumulation unit 21. When there is a display request from the tablet computer 13 or the computer 14, the PDL data is processed by the analysis and conversion processing unit 22, rendered by the rendering unit 23, accumulated in the raster data accumulation unit 24 and transmitted to the display terminal from which the request is issued.

However, the PDL data may also be converted into raster data and accumulated in a searchable manner in the raster data accumulation unit 24 before there is a transmission request from each of the display terminals.

When the PDL data is converted into raster data in advance in this manner, when there is a request from the display terminal the raster data may be transmitted to the terminal quickly. Therefore the display of the document is quickly performed in the display terminal.

### Second Embodiment

Incidentally, in the first embodiment, description is given of an example in which, under the control of the processor, the document is transmitted from the document distribution server to the printer as raster data which is printable substantially unchanged. However, instead of transmitting completely converted raster data from the document distribution server to the printer, intermediate data which is in the middle being converted into raster data from the PDL data, or common analysis data, is transmitted to the printer. Furthermore, the intermediate data or the common analysis data can then be fully converted into raster data in the printer. Such an embodiment will be described next as the second embodiment.

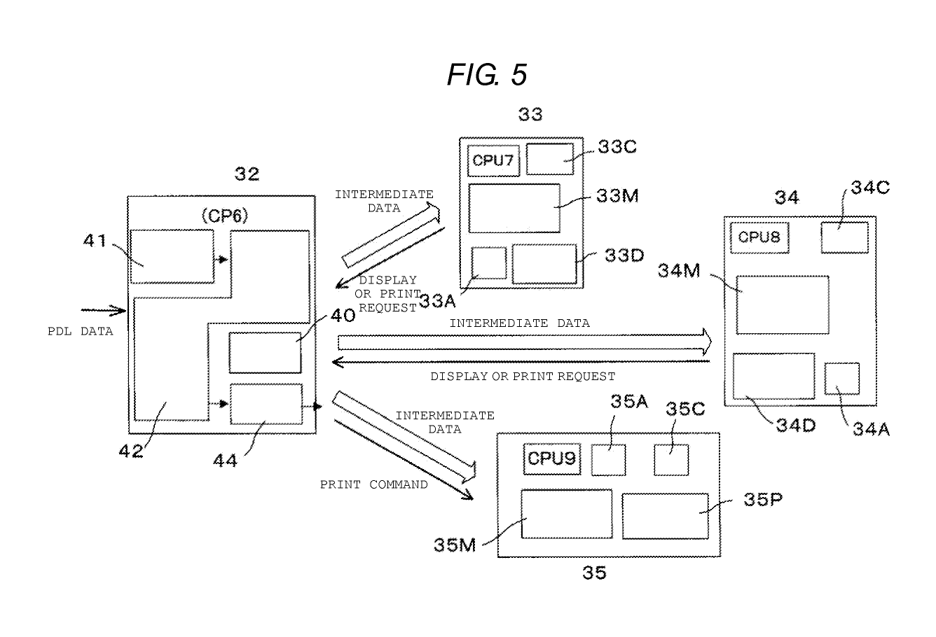

A document distribution system according to the second embodiment is shown in FIG. 5, and includes a PDL document distribution server 32, a tablet computer 33 and a computer 34, and a printer 35. The PDL document distribution server 32 accumulates PDL data, converts the PDL data into intermediate data and accumulates the intermediate data in a searchable manner. The tablet terminal 33 and the computer 34 request the intermediate data or common analysis data, convert the intermediate data or the common analysis data into raster data and display the raster data. The printer 35 receives a print request from the tablet terminal 33 or the computer 34 and prints the document.

In FIG. 5, in order to facilitate understanding of the functions, a CPU 6 is represented separately from a request transceiver unit 40, a PDL data accumulation unit 41, an analysis and intermediate data conversion unit 42 and an intermediate data accumulation unit 44. However, in hardware terms, the CPU 6, which is the computing unit, the memory unit and the input-output control unit are configured integrally, are electrically connected and are controlled by the CPU 6 to perform the functions of each component described below. That is, through control of the CPU 6, the various units perform processes such as reception of the display request signal, accumulation of the PDL data, analysis of the PDL data, conversion into intermediate data, and accumulation of the intermediate data.

The tablet computer 33 includes a CPU 7, a memory unit 33A, a display and print request unit 33C, an intermediate data conversion unit 33M and a display unit 33D. The CPU 7 performs overall control of the tablet computer 33. The display and print request unit 33C transmits the display request signal and the print request signal to the document distribution server 32. The intermediate data conversion unit 33M converts the intermediate data or the common analysis data, which is transmitted from the document distribution server 32, into raster data. The display unit 33D displays the converted raster data.

In FIG. 5, in the tablet terminal 33, the CPU 7 is depicted separately from the other components. However, actually, in hardware terms, the CPU 7, the memory unit 33A, and the external input-output control unit are configured integrally, are electrically connected and perform the functions of each component described above.

The computer 34 includes a CPU 8, a memory unit 34A, a display and print request unit 34C, an intermediate data conversion unit 34M and a display unit 34D. The CPU 8 performs overall control of the various units. The display and print request unit 34C transmits the display request signal and the print request signal, when printing is desired, to the document distribution server 32. The intermediate data conversion unit 34M converts the intermediate data or the common analysis data, which is transmitted from the document distribution server 32, into raster data. The display unit 34D displays the converted raster data.

In FIG. 5, in the computer 34, the CPU 8 is depicted separately from the other components. However, actually, in hardware terms, the CPU 8, the memory unit 34A and the external input-output control unit are configured integrally, are electrically connected and perform the functions of each component described above.

The printer 35 includes an intermediate data conversion unit 45M and a printing unit 45P. The intermediate data conversion unit 45M converts the intermediate data (transmitted from the intermediate data accumulation unit) or the PDL data (the common analysis data transmitted from the PDL data accumulation unit 41) into raster data when the intermediate data conversion unit 45M receives a print command signal from the request transceiver unit 40. The printing unit 45P prints on the basis of the converted raster data.

The document distribution server 32 includes the request transceiver unit 40, the PDL data accumulation unit 41, the analysis and intermediate data conversion unit 42 and the intermediate data accumulation unit 44. The request transceiver unit 40 receives the display request signal and the print request signal from the tablet computer 33 or the computer 34. The request transceiver also transmits the print command signal to the printer 35. The PDL data accumulation unit 41 accumulates the PDL data. The analysis and intermediate data conversion unit 42 analyzes the accumulated PDL data and converts the resultant data into intermediate data. The intermediate data accumulation unit 44 accumulates the obtained intermediate data. Overall control of each of the components is performed by the CPU 6.

The tablet terminal 33 includes a screen of approximately 6 inches to 11 inches, for example, and enables the control of operations through a touch screen interface. Furthermore, the tablet terminal 33 includes the CPU 7, the memory unit 33A, the display unit 33D, and the intermediate data conversion unit 33M. The CPU 7 performs overall control of the tablet terminal 33. The memory unit 33A is controlled by the CPU 7 to store the raster data and the like. The display unit 33D is controlled by the CPU 7 to display the raster data, which is stored by the memory device, on the display screen of the display device. The display and print request unit 33C is controlled by the CPU 7 to generate the display request signal and the print request signal when the display request or the print request is input by a user. The intermediate data conversion unit converts the intermediate data or the common analysis data received from the document distribution server 32 into common format display and printing data.

In FIG. 5, in order to facilitate understanding of the functions, the CPU 6 is represented separately from the request transceiver unit 40, the PDL data accumulation unit 41, the analysis and intermediate data conversion unit 42 and the intermediate data accumulation unit 44. However, in hardware terms, the CPU 6, the memory unit (the ROM and the RAM) and the input-output control unit are configured integrally, are electrically connected and are controlled by the CPU 6 to perform the functions of each component described below, i.e., reception of the display request signal, accumulation of the PDL data, analysis and conversion from the raster data, and the accumulation of the intermediate data.

The computer 34 is a personal computer which includes a CPU 8, a memory unit 34A, the display unit 34D and the intermediate data conversion unit 34M. The memory unit 34A stores the raster data or the like which is transmitted thereto from the document distribution server 32. The display unit 34D is controlled by the CPU 8 to display the raster data, which is stored by the memory unit 34A on the display screen of the display device. The intermediate data conversion unit 34M converts the intermediate data or the common analysis data received from the document distribution server 32 into common format display and printing data.

The printer 35 includes a memory unit 35A and a printing unit 35P. The memory unit 35A receives and temporarily stores the raster data or the like. The printing unit 35P is controlled by the CPU 9 to print when the print command signal is received from the document distribution server.

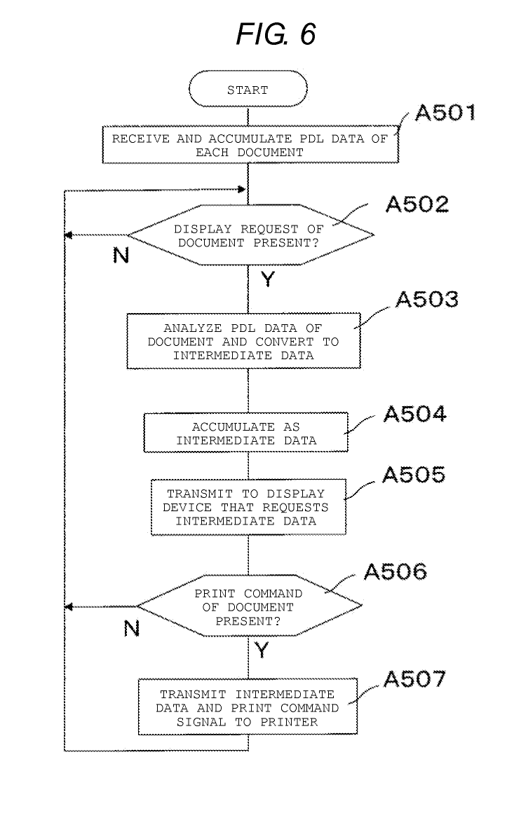

Example operations of the document distribution system according to the second embodiment are shown in the flow chart of FIG. 6. In Act A501, the CPU 6 causes the PDL data accumulation unit 41 in the memory unit to accumulate the PDL data of the document. Under the control of the CPU 6, the list of the documents of the PDL data is transmitted to the display terminal (the tablet computer 33 and the computer 34).

In Act A502, the CPU 6 determines whether or not there is a display request of the document from the display terminals via the request transceiver unit 40. In Act A503, when the CPU 6 determines that there is a display request of the document from the display terminal (Y in A502), the CPU 6 converts the PDL data of the page of the document into intermediate data in the analysis and intermediate data conversion unit 42.

In Act A504, when the analysis and intermediate data conversion unit 42 finishes converting the PDL data into the intermediate data, the CPU 6 accumulates the intermediate data in the intermediate data accumulation unit 44.

In Act A505, the CPU 6 transmits the intermediate data or the common analysis data is accumulated in the intermediate data accumulation unit 44, to the computer 34 that transmitted the display request signal.

In the computer 34 which receives the intermediate data, the CPU 8 converts the intermediate data or the common analysis data into raster data using the intermediate data conversion unit 34M and causes the computer 34 to display the raster data.

In the next Act A506, the CPU 6 determines whether or not the print request signal is received via the request transceiver unit 40.

When the user requests the printing of the document that is being displayed in the computer 34, the CPU 8 generates a display and print request signal using the display and print request unit 34C and transmits the display and print request signal to the document distribution server 32.

In Act A507, when the CPU 6 determines that there is a print request signal via the request transceiver unit 40 (Y in A506), the CPU 6 transmits the intermediate data or the common analysis data and the print command signal to the printer 35, via the intermediate data accumulation unit 44.

In the printer 35, when the CPU 9 detects the intermediate data or the common analysis data and the print command signal is received, the CPU 9 causes an intermediate data conversion unit 35M to convert the received intermediate data or the common analysis data into raster data, and causes the printing unit 35p to print the raster data.

Furthermore, in Act A502, when there is no display request from any of the display terminals, the document distribution server 32 continues monitoring in Act A502 until there is a display request. In addition, when there is no print request of the displayed document from the display terminal that displays the document (N in A506), the process returns to Act A502 and the CPU 6 monitors whether or not the next display request is present.

In this manner, the CPU 6 causes the computer 34 to display the desired document, When the displayed content is to be printed, the content may be printed by the printer 35 in the same format as the displayed content, on the basis of the raster data.

Furthermore, in the second embodiment, when the intermediate data or the common analysis data is transmitted to the display terminal from which there is a display request, instead of transmitting the data to the display terminal, the intermediate data or the common analysis data may also be transmitted to the printer 35. Then, the intermediate data or the common analysis data may be converted to raster data in the intermediate data conversion unit 35M of the printer 35. In such a configuration, printing may be performed quickly using the printer 35 when there is a print request from the display terminal.

In the second embodiment, when there is a display request from one of the display terminals, the PDL data is converted into intermediate data. However, in this embodiment, the PDL data may be converted into intermediate data in advance and accumulated in the intermediate data accumulation unit 44 in a searchable manner. In such a configuration, the time taken to display in the display terminal may be shortened when there is a display request from one of the display terminals.

Furthermore, the intermediate data in the second embodiment is data that is partly converted to raster data, and the data amount may be compressed for more rapid transfer.

In addition, in the second embodiment, any one of PDL data and intermediate data is used. However, an embodiment may also be adopted in which both PDL data and intermediate data are transmitted. Furthermore, the PDL data may be only the PDL data itself, or it may also be a combination of predetermined data with the PDL data. Examples of combinations with predetermined data include annotations, overlays, tags and written data.

In the embodiment, the PDL data is converted into raster data for printing by using a RIP program in the document distribution server. However, an alternative embodiment may convert the PDL data into raster data using another conversion method, instead of or in addition to using RIP.

In addition, in the embodiment, printing is performed by the printer on the basis of raster data. The raster data, in an exemplary embodiment, is data which is converted into a format in which the display mode does not change even when the data is enlarged or reduced, in the same manner as dot data, which is a collection of dots.

However, a printer which prints on the basis of other printing data instead of the raster data may also be used. In other words, a characteristic of the exemplary embodiment is that data that used is printed by the printing device in the same manner as the display in the display terminal. Here, such data is referred to as “the common format data.”

In addition, when the printer converts intermediate data into raster data, and the tablet or the computer do not convert the intermediate data or the common analysis data into raster data, the intermediate data is transmitted from the document distribution server to the printer and raster data is transmitted to the tablet or the computer. In this case, also, the raster data is defined as “the common format data” in the embodiment.

In the embodiment, each of the components included in the document distribution server perform the processing. However, the processes of each of the components may also be performed using a program for a document distribution server, which is installed on the document distribution server.

As described above, according to an embodiment, after displaying a document on the screen of the display terminal, the document may be printed in the same format mode.

In the embodiments, any of the processes described above can be accomplished by a computer-executable program, and this program can be embodied in a non-transitory computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above. Furthermore, based on an instruction in the installed program, an OS (operating system) of the computer, or MW (middleware software), such as database management software or network, may execute one or more parts of the processes described above to realize the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A document distribution server comprising:
a data conversion unit configured to convert document data into a common format data that have the same appearance when displayed on a display device and when printed with a printing device;
a receiving unit configured to receive a request to display the document data in the display device and to receive a request to print the document data in the printing device; and
a transmission unit configured to transmit the common format data to the display device when the request to display the document data is received from the display device and to transmit the common format data to the printing device when the request to print the document data is received from the printing device.

2. The document distribution server according to claim 1, wherein the common format data is raster data.

3. The document distribution server according to claim 1, wherein the document data is a page description language document.

4. The document distribution server according to claim 1, wherein the document data is created in an external device and transmitted to the document distribution server.

5. The document distribution server according to claim 1, wherein the data conversion unit is a raster image processor.

6. The document distribution server according to claim 1, further comprising a storage unit that stores the common format data in a searchable manner.

7. The document distribution server according to claim 1, wherein the data conversion unit converts the document data after the request to display the document data is received.

8. A document distribution server comprising:
a data conversion unit configured to convert document data into intermediate data that can be converted to a common format data that have the same appearance when displayed on a display device and when printed with a printing device;
a receiving unit configured to receive a request to display the document data in the display device and to receive a request to print the document data in the printing device; and
a transmission unit configured to transmit the intermediate data to the display device when the request to display the document data is received from the display device and to transmit the intermediate data to the printing device when the request to print the document data is received from the display device.

9. The document distribution server according to claim 8, wherein the common format data is raster data.

10. The document distribution server according to claim 8, wherein the document data is a page description language document.

11. The document distribution server according to claim 8, wherein the document data is created in an external device and transmitted to the document distribution server.

12. The document distribution server according to claim 8, further comprising a storage unit that stores the common format data in a searchable manner.

13. The document distribution server according to claim 8, wherein the data conversion unit converts the document data after the request to display the document data is received.

14. A non-transitory computer readable medium comprising instructions for causing a server to carry out a method of distributing document data, the method comprising the steps of:
receiving a request to display the document data;
converting document data into one of a common format data that have the same appearance when displayed on a display device and when printed with a printing device and an intermediate data that can be converted to the common format data;
transmitting the one of the common format data and the intermediate data to the display device when the request to display the document data is received from the display device and to the printing device when the request to print the document data is received from the display device.

15. The non-transitory computer readable medium according to claim 14, wherein the common format data is raster data.

16. The non-transitory computer readable medium according to claim 14, wherein the document data is a page description language document.

17. The non-transitory computer readable medium according to claim 14, wherein the document data is created in an external device and transmitted to the document distribution server.

18. The non-transitory computer readable medium according to claim 14, wherein the method further comprises the step of:
storing the one of the common format data and the intermediate format in a searchable manner.
